(19) United States
(12) Patent Application Publication
(10) Pub. No.: US 2012/0234300 A1
(43) Pub. Date: Sep. 20, 2012

(54) TANK SYSTEM FOR A MOTOR VEHICLE

(75) Inventor: Andreas Menke, Tiefenbronn Lehningen (DE)

(73) Assignee: Dr. Ing. h.c.F. Porsche Aktiengesellschaft, Stuttgart (DE)

(21) Appl. No.: 13/419,985

(22) Filed: Mar. 14, 2012

(30) Foreign Application Priority Data
Mar. 16, 2011 (DE) 10 2011 001 310.5

(51) Int. Cl. F02M 33/02

(52) U.S. Cl. 123/519; 180/65.21

(57) ABSTRACT

A tank system (1) for a motor vehicle having an internal combustion engine to which fuel is supplied from a tank (2), wherein the tank (2) is assigned, in a ventilation path to the atmosphere (7), a flushable filter device (6, 6) for being loaded with hydrocarbon vapors of the fuel. The filter device (6, 6) has multiple mutually separate activated carbon filters (6). All of the activated carbon filters (6) are connected permanently in parallel. In this way, the ventilation resistance from the tank in the direction of the atmosphere can be kept low.

### CROSS REFERENCE TO RELATED APPLICATION

This application claims priority under 35 USC 119 to German Patent Application No 10 2011 001 310.5 filed on Mar. 16, 2011, the entire disclosure of which is incorporated herein by reference.

### BACKGROUND OF THE INVENTION

1. Field of the Invention

The invention relates to a tank system for a motor vehicle having an internal combustion engine and a tank that supplies fuel to the internal combustion engine. A ventilation path extends from the tank to the atmosphere and a flushable filter device is in the ventilation path. The filter device can be loaded with hydrocarbon vapors of the fuel and has multiple mutually separate activated carbon filters.

2. Description of the Related Art

Hydrocarbon vapors accumulate within the fuel tank of a motor vehicle during fueling and also while driving. It is desirable to prevent the hydrocarbon vapors from passing into the atmosphere. The tank therefore has a flushable filter device in a ventilation path to the atmosphere. The filter device can be loaded with hydrocarbon vapors of the fuel. The filter device is flushed from time to time and the hydrocarbon vapors bound therein are conducted to the internal combustion engine for burning, thereby emptying the filter device.

A tank system designed according to the features mentioned in the introduction is known from DE 197 56 606 A1 discloses a tank system with two activated carbon filters connected in series in a first operating state. However, the tank system also has a bypass so that in a second operating state a partial flow can be conducted directly to the downstream activated carbon filter.

U.S. Pat. No. 3,352,294 describes an arrangement of an internal combustion engine with a carburetor, and of a tank system with two activated carbon filters. One of the activated carbon filters is arranged in the ventilation path of the tank to the atmosphere. The other activated carbon filter is assigned to a float chamber of the carburetor.

US 2007/0199547 A1 describes an activated carbon filter of modular construction.

It is an object of the present invention to further develop a tank system so that the ventilation resistance from the tank in the direction of the atmosphere is low.

### SUMMARY OF THE INVENTION

The invention relates to a tank system where plural activated carbon filters are connected permanently in parallel. In particular, two or four activated carbon filters are provided. If four activated carbon filters are used, in each case two activated carbon filters form a filter pair.

The mutually separate activated carbon filters connected in parallel achieves lower flow resistance for the filter device. This is particularly advantageous in the case of pressurized tank systems and in which the fueling ventilation path is conducted via the filter device. More particularly, there is the problem that the resistance of a pressure-holding valve of the pressurized tank system adds to the resistance of the filter device during fueling. If a limit resistance is exceeded, fuelling is then no longer possible at all, or possible only to a restricted extent.

The tank system may be a normal or pressurized tank system. In the case of the pressurized tank system, a pressure prevails that is elevated in relation to ambient pressure. The elevated pressure is ensured by the pressure-holding valve.

If two filter pairs are used, one filter pair is assigned to a ventilation path to the atmosphere during the fueling of the vehicle, and the other filter pair is assigned to a ventilation path to the atmosphere during operation of the vehicle.

It is preferable for two identical activated carbon filters, or two identical activated carbon filters in the respective filter pair, to be used. The activated carbon filters are loaded and flushed in accordance with the volume flow distribution. The total absorption capacity of the two individual activated carbon filters should be dimensioned to be slightly larger than the absorption capacity of a single large activated carbon filter due to component deviations of the activated carbon filters.

The vehicle preferably is a hybrid vehicle, a plug-in hybrid or a motor vehicle with a start-stop device. In such vehicles, it is important to keep the vapor formation in the tank, and therefore to keep loading of the activated carbon filter low. The design of the tank system of the invention is basically independent of the type of motor vehicle.

Further features of the invention will emerge from the claims, from the appended drawing and from the description of the preferred exemplary embodiments depicted in the drawing, without the invention being restricted to these.

### BRIEF DESCRIPTION OF THE DRAWINGS

FIG. 1 is a first exemplary embodiment of the parallel arrangement of activated carbon filters in the tank system for the motor vehicle.

FIG. 2 shows a second exemplary embodiment of the parallel arrangement of activated carbon filters in the tank system for the motor vehicle.

### DETAILED DESCRIPTION OF THE PREFERRED EMBODIMENTS

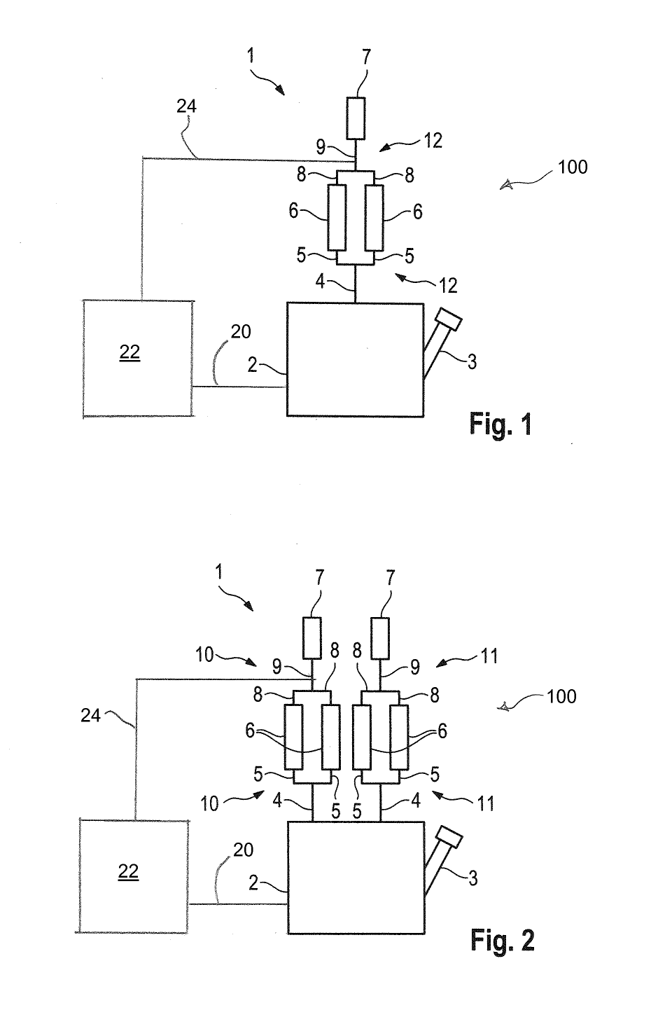

The tank systems 1 shown in FIGS. 1 and 2 are used in a hybrid vehicle, a plug-in hybrid vehicle or a motor vehicle with a start-stop device. The vehicle is identified generally by the numeral 100 in FIGS. 1 and 2.

The tank system 1 of FIG. 1 has a tank 2 for fuel. The tank 2 has a filler neck 3 that can be closed off. Fuel lines 20 extend from the tank 2 to an internal combustion engine 22 of the motor vehicle are not shown. Hydrocarbon vapors of the fuel accumulate in the tank 2 during fueling of the tank and during operation of the vehicle and the internal combustion engine. These hydrocarbon vapors are conducted via a ventilation path 12 to the atmosphere. The ventilation path 12 is formed by a ventilation line 4 that is connected to the tank 2 and which, proceeding from the tank 2, splits into two line portions 5. Each line portion 5 is connected to an activated carbon filter 6. The two activated carbon filters 6 are separate from one another and are connected permanently in parallel. The filter device formed by the two activated carbon filters 6 can be flushed from time to time so that the hydrocarbon vapors bound therein are conducted to the internal combustion engine 22 via feed lines 24 for burning so that the filter device is emptied. The reference numeral 7 denotes the atmosphere to which the ventilation path 12 runs from the tank 2 and the activated carbon filters 6. The two activated carbon filters 6 are connected for example via line portions 8 and an adjoining, common line 9 to the atmosphere 7.

The tank system 1 is designed so that the tank 2 is pressurized to reduce the vapor generation in the tank during operation and during fuelling. In the ideal case, the tank 2 is completely closed off. The tank 2 therefore is pressurized by a pressure-holding valve and protected against negative pressure by a negative pressure protection valve. The pressurization with the hold pressure is desirable to minimize the vapor emissions. Thus, the resistance in the ventilation path 12 of the activated carbon filter must be lowered. For this reason, the two activated carbon filters 6 connected permanently in parallel are arranged in the ventilation path 12. These are preferably two identical activated carbon filters 6 and are loaded, and likewise flushed, in accordance with the volume flow distribution. Small deviations of the components with respect to one another are inevitable. Thus, it is not possible to obtain exactly identical loadings and regeneration. Thus, the total absorption capacity of the two activated carbon filters 6 is slightly larger than the absorption capacity of a single, large activated carbon filter.

The embodiment according of FIG. 2 differs from FIG. 1 merely in that two ventilation paths 10, 11 run from the tank 2 to the atmosphere. Each ventilation path is assigned a pair of activated carbon filters 6. Thus four activated carbon filters 6 are provided, which may self-evidently also differ. One ventilation path 10 is provided for the fueling function and the other ventilation path 11 is provided for the ventilation function during operation of the motor vehicle and of the internal combustion engine. This permits selective or simultaneous loading of the activated carbon filters 6 during the “fueling” function and “during operation”.

The components that correspond in both embodiments are denoted by the same reference numerals in FIGS. 1 and 2.

The resistance during the ventilation of the tank is made up of different components. For example, a resistance during the tank ventilation is generated for example by lines, valves and the like, and also by the resistance of the activated carbon filters 6. Further resistances during the tank ventilation are generated due to the line conditions and the like between the activated carbon filters 6 and the atmosphere 7.

What is claimed is:

1. A tank system for a motor vehicle having an internal combustion engine and a tank that supplies fuel to the internal combustion engine, a ventilation path extending from the tank to atmosphere, a flushable filter device for being loaded with hydrocarbon vapors of the fuel in the ventilation path, the filter device having multiple mutually separate activated carbon filters connected permanently in parallel.

2. The tank system of claim 1, wherein two activated carbon filters are provided.

3. The tank system of claim 1, wherein tank system is a non-pressurized or a pressurized tank system.

4. The tank system of claim 1, wherein a fueling ventilation path is conducted via the filter device.

5. The tank system of claim 1, wherein all of the activated carbon filters are identical.

6. The tank system of claim 1, wherein the total absorption capacity of the activated carbon filters is slightly larger than the absorption capacity of a single large activated carbon filter.

7. The tank system of claim 1, wherein four activated carbon filters are provided, wherein in each case two activated carbon filters form a filter pair.

8. The tank system of claim 7, wherein one filter pair is assigned to a ventilation path to the atmosphere during the fueling of the vehicle, and the other filter pair is assigned to a ventilation path to the atmosphere during operation of the vehicle.

9. The tank system of claim 1, characterized in that said tank system is a tank system of a hybrid vehicle, of a plug-in hybrid vehicle or of a motor vehicle with a start-stop device.

10. A motor vehicle comprising:
an internal combustion engine;
a tank that supplies fuel to the internal combustion engine;
at least one ventilation assembly extending from the tank to atmosphere, the ventilation assembly comprising plural flushable activated carbon filter devices for retaining hydrocarbons in vapors from the fuel in the tank, the plural hydrocarbon filter devices in the at least one ventilation assembly being connected permanently in parallel.

11. The motor vehicle of claim 10, further comprising at least one feed line extending from a position in the at least one ventilation assembly downstream of the plural flushable activated carbon filter devices to the internal combustion engine for selectively burning hydrocarbons flushed from the flushable activated carbon filter devices.

12. The motor vehicle of claim 11, wherein the at least one ventilation assembly extending from the tank to atmosphere, comprises first and second ventilation assemblies each of which has plural flushable activated carbon filter devices connected permanently in parallel.

13. The motor vehicle of claim 12, wherein the first ventilation assembly is assigned to a ventilation path to the atmosphere during fueling of the vehicle, and the second ventilation assembly is assigned to a ventilation path to the atmosphere during operation of the vehicle.

14. The motor vehicle of claim 10, wherein tank system is a pressurized tank system.

15. The motor vehicle of claim 10, wherein tank system is a non-pressurized tank system.

16. The motor vehicle of claim 10, wherein the motor vehicle is a hybrid vehicle, a plug-in hybrid vehicle or a motor vehicle with a start-stop device.
